(19) United States
(12) Patent Application Publication
(10) Pub. No.: US 2012/0136728 A1
(43) Pub. Date: May 31, 2012

(54) NETWORKED ADVERTISEMENT EXCHANGE

(75) Inventors: Daniel Wei-Tze Hsiung, San Francisco, CA (US); lan Graeme Melven, San Francisco, CA (US); Giao Huu Phan, San Francisco, CA (US); Marshall Allen Beddoe, San Francisco, CA (US); Dru Nelson, San Carlos, CA (US)

(73) Assignee: BRIGHTROLL, INC., San Francisco, CA (US)

(21) Appl. No.: 12/956,888

(22) Filed: Nov. 30, 2010

(51) Int. Cl. G06Q 30/00

(52) U.S. Cl. 705/14.71

(57) ABSTRACT

A networked advertisement exchange system is described. The system includes a memory comprising a set of exchange rules, and a processor. The processor is configured to receive, from a client, an advertisement request, send, to each of a plurality of advertisement servers, a right-to-bid request, and receive, from each of the plurality of advertisement servers, a response to the right-to-bid request, each response comprising a bid price or a pass. The processor is also configured to select, based on the set of exchange rules, the winning response from the plurality of responses, and provide, to the client in response to the advertisement request, information for an advertisement associated with the winning response. The advertisement is a video. Methods and machine-readable media are also described.

### BACKGROUND

1. Field

The present disclosure generally relates to networked systems, and specifically to a networked system for the exchange of advertisements.

2. Description of the Related Art

Many companies seek to attract customers by promoting their products or services as widely as possible. Online advertising is a form of promotion that uses the Internet and World Wide Web for the expressed purpose of delivering marketing messages to attract customers. Online advertising is often facilitated through companies called online advertising networks that connect advertisers to web sites that want to sell advertising space. The key function of an advertising network is aggregation of advertisement space supply from publishers and matching it with advertiser demand. Advertisement exchanges are technology platforms used by online advertising networks, agencies, advertisers, and others for buying and selling online advertisement impressions. Advertisement exchanges can be useful to both buyers (advertisers and agencies) and sellers (online publishers) because of the efficiencies they provide. Advertisement exchanges are, however, often limited by the types of advertisements they can buy and sell, their inventory size, and abilities to target specific viewers (e.g., potential customers).

### SUMMARY

What is needed then is an advertisement exchange that is less limited in the types of advertisements it can buy and sell, in inventory size, and that has the ability to target specific viewers. The disclosed advertisement exchange, according to certain embodiments, is configured to buy and sell many types of advertisements, such as video, with advanced targeting features and access to a large volume of inventory and publishers. The disclosed advertisement exchange is configured to process, in real-time, a received request for a video advertisement and respond, based on a set of rules, with a winning video advertisement, selected from among a plurality of video advertisements, from a plurality of advertisement servers (e.g., from one or many companies), that were bid in response to the request.

In certain embodiments, a networked advertisement exchange system is provided. The system includes a memory comprising a set of exchange rules, and a processor. The processor is configured to receive, from a client, an advertisement request, send, to each of a plurality of advertisement servers, a right-to-bid request, and receive, from each of the plurality of advertisement servers, a response to the right-to-bid request, each response comprising a bid price or a pass. The processor is also configured to select, based on the set of exchange rules, the winning response from the plurality of responses, and provide, to the client in response to the advertisement request, information for an advertisement associated with the winning response. The advertisement is a video.

In certain embodiments, a method for procuring placement of an advertisement over a network is provided. The method includes receiving, from a client, an advertisement request, sending a right-to-bid request to each of a plurality of advertisement servers, and receiving, from each of the plurality of advertisement servers, a response to the right-to-bid request, each response comprising a bid price or a pass. The method also includes selecting, based on a set of exchange rules, the winning response from the plurality of responses, and providing, to the client in response to the advertisement request, information for an advertisement associated with the winning response. The advertisement is a video.

In certain embodiments, a machine-readable medium comprising machine-readable instructions for causing a processor to execute a method for procuring placement of an advertisement over a network is provided. The method includes receiving, from a client, an advertisement request, sending a right-to-bid request to each of a plurality of advertisement servers, and receiving, from each of the plurality of advertisement servers, a response to the right-to-bid request, each response comprising a bid price or a pass. The method also includes selecting, based on a set of exchange rules, the winning response from the plurality of responses, and providing, to the client in response to the advertisement request, information for an advertisement associated with the winning response. The advertisement is a video.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A illustrates an exemplary architecture for a networked advertisement exchange system.

FIGS. 1B and 1C are exemplary screenshots that illustrate various user interfaces for the system of FIG. 1A.

FIG. 2 is an exemplary process for procuring placement of an advertisement over a network using the system of FIG. 1A.

FIGS. 3A-3D are exemplary screenshots that illustrate various steps of the process of FIG. 2.

FIG. 4 is a block diagram illustrating an example of a computer system with which the networked advertisement exchange system of FIG. 1A can be implemented.

### DETAILED DESCRIPTION

In the following detailed description, numerous specific details are set forth to provide a full understanding of the present disclosure. It will be obvious, however, to one ordinarily skilled in the art that the embodiments of the present disclosure may be practiced without some of these specific details. In other instances, well-known structures and techniques have not been shown in detail so as not to obscure the disclosure.

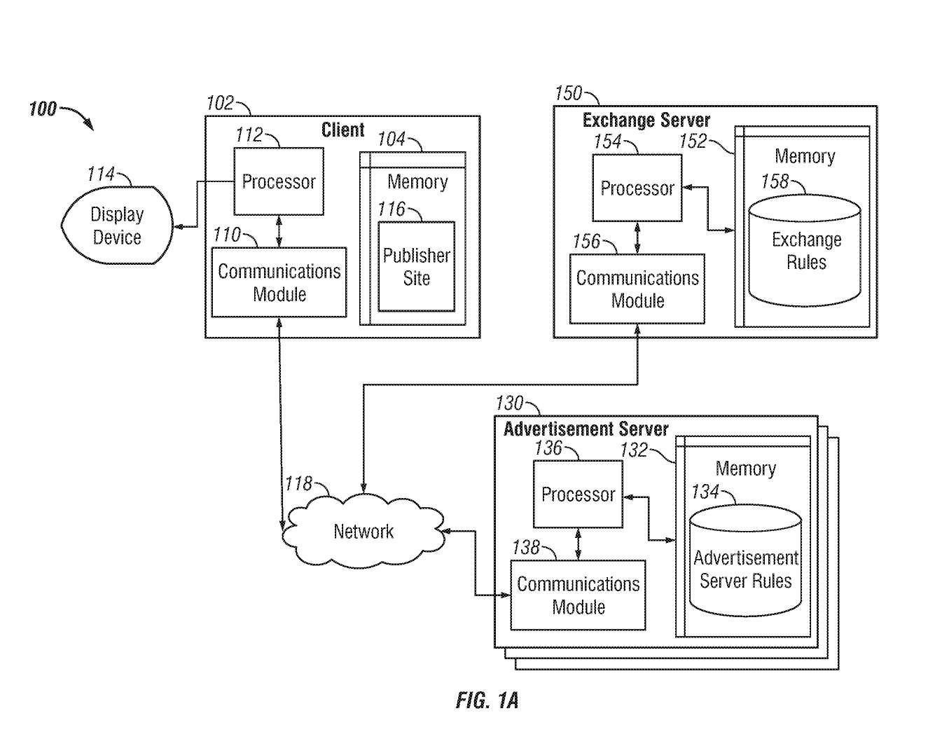

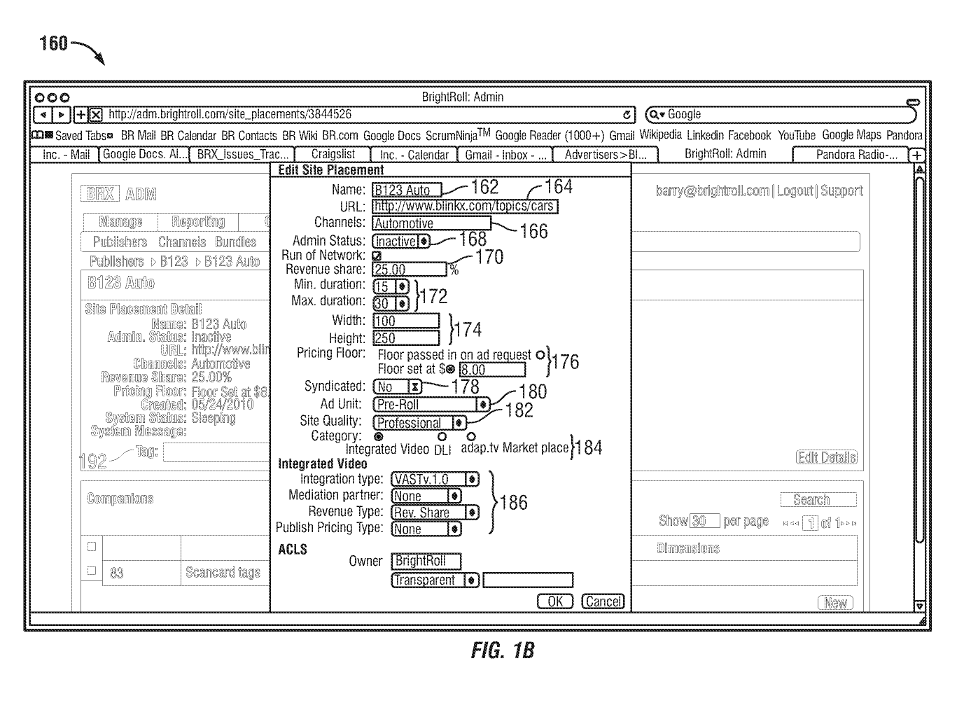

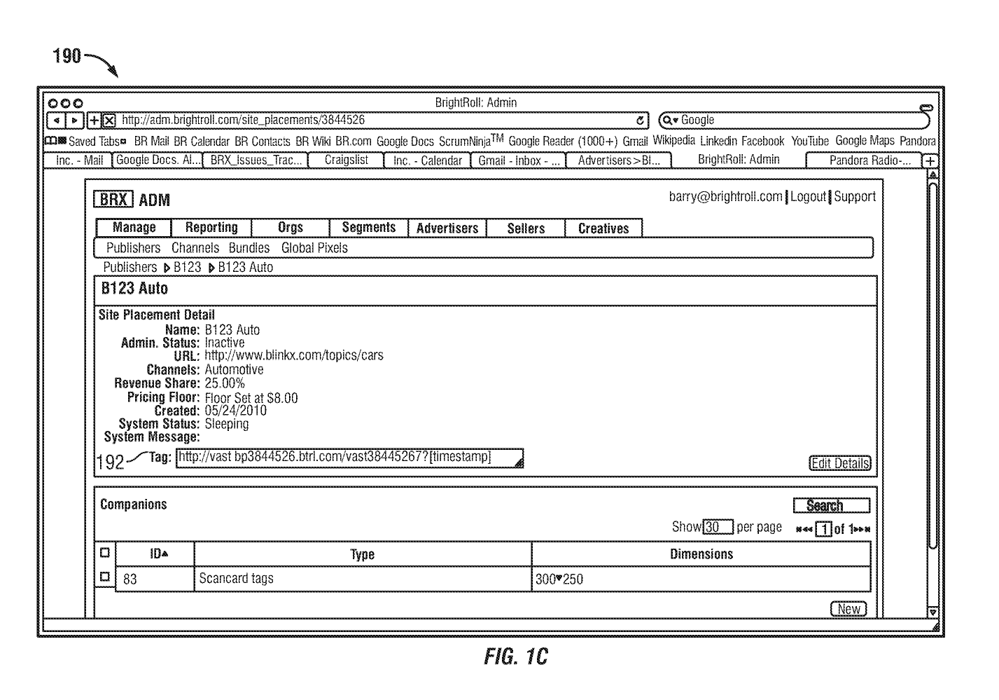

FIG. 1A illustrates an exemplary architecture 100 for a networked advertisement exchange system 150. The architecture includes a client 102, an exchange server 150 (the “networked advertisement exchange system” or “advertisement exchange”), and a plurality of advertisement servers, represented by exemplary advertisement server 130. The advertisement server 130 is associated with advertisements for one or a plurality of advertisers (or “buyers”). The client 102 can be, for example, a desktop computer, a mobile computer, a set top box (for a television), a video game console, a mobile device, or any other device having an appropriate display device 114.

The client 102, the exchange server 150, and the advertisement server 130 are connected over a network 118 via respective communications modules 110, 156, and 138. The network 118 can be, for example, a Local Area Network such as a private communications network or a Wide Area Network such as the Internet. The communications modules 110, 156, and 138 can be, for example, modems or Ethernet cards.

The exchange server 150 includes a processor 154, the communications module 156, and a memory 152 that includes exchange rules 158 (or “set of exchange rules”) that may be implemented in various ways, such as by using any combination of databases or tracking modules (e.g., “cookies”). The processor 154 of the exchange server 150 is configured to execute instructions, such as instructions physically coded into the processor 154, instructions received from software in memory 152, or a combination of both. For example, the processor 154 of the exchange server 150 is configured to receive an advertisement request, from a site or “publisher” (e.g., web site) being viewed on the client 102, to display an advertisement on the client 102, such as a request for a video advertisement. Other types of advertisements can be requested and processed by the exchange server 150, such as, and without limitation audio advertisements, image advertisements, in-game advertisements, interactive advertisements. The advertisement request may thus, in certain embodiments, be generated by the site, but then transmitted via the client 102 to the exchange server 150 using the processor 112 of the client and the communications module 110.

In certain embodiments, the advertisement request to the exchange server 150 includes an IP address (e.g., for geographic location or “geo-targeting” of the client 102), advertisement format information (e.g., a size, duration, and/or encoding format of an acceptable advertisement), and publisher site information for the site 116 that will display, on the client 102, the advertisement (e.g., the web site address or the type of web site) (hereinafter “publisher site 116” or “publisher 116,” an illustrated in FIG. 1 as having been loaded into the memory 116 of the client 102, such as by a web browser). In certain embodiments, the advertisement request to the exchange server 150 also includes pricing information (e.g., a lowest price or “floor” that the publisher site 116 is willing to accept as payment to display the advertisement), historical information (e.g., tracking modules that include identifying information of the client 102, such as a past browsing history of the client 102), or client information. The request is issued from, for example, the publisher site 116 using a web browser or an Adobe Flash® player stored in the memory 104 of the client 102. As discussed herein, the requests and responses for information between the client 102, exchange server 150, and advertisement servers 130 are appropriately formatted to facilitate communication. For example, in certain embodiments, the requests and responses are formatted in accordance with Video Ad Serving Template (VAST) standards where appropriate, although other formatting may be used.

The processor 154 of the exchange server 150 is also configured to send, to each of the plurality of advertisement servers 130, a right-to-bid request that is based on the advertisement request. By being able to request advertisements from a plurality of advertisement servers 130, the exchange server 150 advantageously has access to a large inventory of advertisements commensurate with the inventories of each of the advertisement servers 130. The right-to-bid request is transmitted using the respective communications modules 156 and 138 of the exchange server 150 and the advertisement server 130.

In certain embodiments, the right-to-bid request sent by the exchange server 150 to each of the advertisement servers 130 includes an IP address, advertisement information, pricing information, publisher site information, inventory information, a time (e.g., a current time of day or “daypart”), a cookie mapping of the exchange cookie's ID to the ad server's cookie ID, or other client information. The publisher site information included in the right-to-bid request can include behavioral targeting information, such as contextual data obtained from searching the Internet to obtain information on the publisher site 116 (e.g., the publisher site 116 address, the publisher site 116 is about a certain topic, and because the advertisement request is originating from the publisher site 116, an advertiser may seek to place an advertisement relevant to the topic on the publisher site 116). As another example, publisher site information can be included that indicates that the publisher site 116 is demographically targeted to eighteen year old males. Other exemplary publisher site information includes a historical value of placing an advertisement on the publisher site 116 (e.g., a historical clearing price for the publisher site 116 that indicates, for example, that a certain bidding price would likely win, or an average bidding price for the publisher site 116 over a certain time period), site property information (e.g., whether the publisher site 116 is a web site, a software application, a video game, a television channel, etc.), bundle information (e.g., whether a publisher site 116 is part of a group of sites that share a common feature, such as being highly frequented or targeted toward a certain audience), and quality information (e.g., whether the publisher site 116 is a broadcast site, professionally developed, user generated, etc.). In certain embodiments, a determinant of a bid price for an advertisement is data contained within an advertisement server's cookie on the client 102, which can be seen directly if the right-to-bid request comes from the browser on the client 102, and can also be accessed by mapping the advertisement server cookie identification to the exchange cookie identification if the right-to-bid request comes from the exchange server 150.

As yet a further example, publisher site information can include information on the value of the publisher site 116 to advertisers, such as a historical quality score or value of the placement of the advertisement on the publisher site 116 to the advertiser based on predetermined metrics (e.g., how the publisher site 116 has performed, advertisement conversion information, advertisement click information, advertisement finish-rate information). The client information included in the right-to-bid request sent by the exchange server 150 to the advertisement servers 130 can include a geographic location of the client (e.g., obtained based on the client's Internet Protocol (IP) address). Client information to be included may be obtained, for example, using tracking modules that are based on a user (“the user”) of the client 102. For example, client information may be included that was obtained from a determination, using tracking modules, that the user is friends with certain people that are known to have a certain behavior.

In certain embodiments, the advertisement server 130 indicates to the exchange server 150 that it does not want to receive certain right-to-bid requests, and such indicators are stored in the exchange rules 158. For example, a certain advertiser associated with the advertisement server 130 may not want to receive over a certain number of right-to-bid requests, or right-to-bid requests associated with violent content, and so an appropriate filter may be established in the exchange rules 158 in the memory 152 of the exchange server 150.

The processor 154 of the exchange server 150 is further configured to receive, from each of the plurality of advertisement servers 130, a response to the right-to-bid request. Each response includes an indicator of a bid price or a pass (or a “no advertisement” response). The response is based on advertisement server rules 132 (or “set of advertisement rules”) stored in the memory 132 of the respective advertisement server 130. Other server rules 132 taken into consideration when generating the response include, for example, frequency cap rules (e.g., how many times serve an advertisement to a user), pacing rules (e.g., serving a certain volume of advertisements for an advertisement campaign over a certain time period), flight date rules (e.g., start and end dates for an advertisement campaign), and targeting rules (e.g., geographic targeting, advertisement or site category information, user value information, bundle information). The targeting rules may indicate, for example, that the advertiser does not want to bid on placing advertisements on certain publisher sites, such as where the buyer seeks to place advertisements for a first service, but does not wish to place those advertisements on the publisher site of a competing service.

In certain embodiments, each response to the right-to-bid request sent by the advertisement server 130 further includes information on a bid advertisement (i.e., the advertisement the response is bidding on to have played on the client 102) or a tracking module. Exemplary information on the bid advertisement includes the bid advertisement to display, a location from which the bid advertisement can be obtained and/or displayed, a companion (e.g., banner) to display with the bid advertisement, destination information (e.g., actions to take if the bid advertisement is activated or “clicked”), and bid advertisement format information (e.g., the size, type, frame rate, aspect ratio, dimensions, and/or duration of the bid advertisement). In certain embodiments, the response to the right-to-bid request includes goal information. For example, the goal information may indicate that an advertiser wants to generate a certain cluster rate, so the exchange server 150 would automatically run advertisements for the advertiser until certain cost per click rate or conversion rate is reached. As another example, the goal information may indicate that the advertiser wants to try to have a certain price cost per impression or payment goals, which would then be handled by the exchange server 150. By way of another example, the tracking module may indicate whether the client 102 has visited a related site before. If the client 102 has visited a related site, a first bid advertisement associated with the related site may be offered, but if the client 102 has not visited the related site, a second bid advertisement not associated with the related site may be offered.

The processor 154 of the exchange server 150 is also configured to select, based on the exchange rules 158, the winning response from the plurality of responses to the right-to-bid requests. In certain embodiments, the set of exchange rules 158 comprises rules associated with a publisher site 116 on which to display the advertisement, pricing information, or advertisement format information. Exemplary exchange rules 158, include, by way of example and without limitation, whether (1) the placement of the advertisement on the publisher site 116 will match one, many, or all of the targeting criteria for the advertisement (e.g., geographical location, time of day, channel, site quality), (2) the advertisement is being placed at a rate that it should be eligible for bidding, (3) the advertisement is within all flighting and pricing/budget constraints, (4) the bid (e.g., payment) to place the advertisement on the publisher site 116 clears any existing publisher site 116 placement minimum bid acceptance price (or “floor”), for example, when the exchange server 150 subtracts a cost (or “revenue share”) for placing the advertisement, and (5) whether the bid is the highest bid among all available bids included in the received responses. Additional exemplary exchange rules 158 include whether (6) the publisher site 116 is active, (7) publisher site information, such as the owner or content of the publisher site 116 (e.g., to avoid placing an advertisement for a company on the site of a rival company), whether it is syndicated (e.g., to place advertisements for a specific product in a category on a first publisher site 116, but place advertisements for any product in the category on syndicated publisher sites of the first publisher site 116), and whether the publisher site 116 accepts advertisements in a certain category (e.g., a children's publisher site not accepting tobacco advertisements), (8) advertisement format (e.g., whether the bid advertisement is too long or too short for placement on the publisher site 116), and (9) exchange server pricing information (e.g., revenue share—if the exchange server 150 extracts a certain cost for connecting the advertisement server 130 response to the client 102, then determining whether, after the cost is extracted, the bid price is sufficient to win).

FIG. 1B illustrates an exemplary screenshot 160 of a site placement entry from the exchange rules 158 stored in the memory 152 of the exchange server 150. The entry includes information on the name 162 of the publisher site, the address 164 of the publisher site, the channel 166 of the publisher site, the administrative status 168 of the publisher site, the revenue share 170 extracted by the exchange server 150, the duration range of the advertisement space 172, the sizing of the advertisement space 174, the pricing floor of the publisher site 176, whether the publisher site is syndicated 178, what type of ad-unit the publisher site is requesting 180, the publisher site quality 182, the site category information 184, and integrated video information 186 for the publisher site.

Once the winning response is selected, the processor 154 of the exchange server 150 is configured to provide, to the client 102 in response to the advertisement request, information for an advertisement associated with the winning response (“winning advertisement”) for display on the publisher site. The provided information is in a format suitable for processing by the client 102 to facilitate display of the winning advertisement. In certain embodiments, the advertisement is served in a linear media consumption environment before or in-between media content, such as video (e.g., a television episode or movie), audio (e.g., a song or lecture), a game (e.g., a flash game), another advertisement, an image (e.g., a slideshow), or an internet web page. In certain embodiments, as discussed above, the winning advertisement is provided to the client 102 and served on the client 102. In certain embodiments, the winning advertisement is served from the exchange server 150. In certain embodiments, the winning advertisement is served from the advertisement server 130. In certain embodiments, the winning advertisement is served from the advertisement server 130 after being redirected from the exchange server 150. For example, the exchange server 150 provides information for the winning advertisement to the client 102, the information including the winning advertisement information wrapped in exchange server data tags so that, when the client 102 processes the tags and is directed to the exchange server 150 (e.g., so that an impression pixel is fired, indicating the advertisement has been served to the client 102), the exchange server 150 then directs the client 102 to the location of the winning advertisement so that it can be played on the client 102. FIG. 1C illustrates an exemplary screenshot 160 of an exchange server tag 192 that is sent to the publisher site 116 after the site placement entry of FIG. 1B.

In certain embodiments, the publisher site 116 is not required to display the winning advertisement, such as where, for example, the publisher site 116 has obtained winning advertisement information from an internal ad server or multiple exchange servers and decides to display the winning advertisement having the highest bid price among all received winning advertisements.

In certain embodiments, the exchange server 150 is configured to provide real-time or near real-time reports that provide a breakdown by, for example, campaign, placement, creative, geographic location, publisher site 116, conversion rates, information on key metrics such as impressions, clicks, click through rate (CTR), cost per impression (CPM), and cost. The reports can be pulled by date range, interval, time zone, and advertiser.

Although the architecture 100 of FIG. 1A illustrates a plurality of advertisement servers 130 each having advertisement server rules 134 stored separately and remotely from the exchange server 150, in certain embodiments, each advertisement server 130 may store its respective advertisement server rules 134 in the memory 152 of the exchange server 150. In these embodiments, the exchange server 150 does not need to send a right-to-bid request to the advertisement server 130, but instead determines which advertisement will win the right to be displayed on the client 102 based on the locally stored advertisement server rules 134, for each advertisement server 130, stored locally in the memory 152 of the exchange server 150.

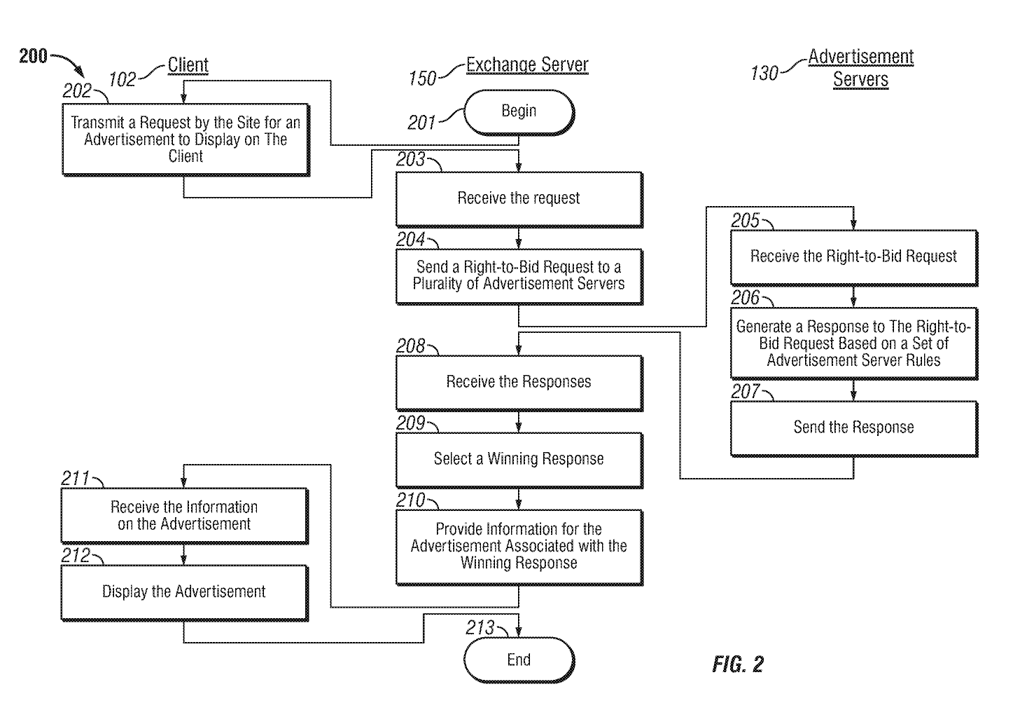

FIG. 2 is an exemplary process 200 for procuring placement of an advertisement over a network 118 using the exchange server 150 of FIG. 1A. The process 200 occurs in near real-time. For example, in certain embodiments, depending on the speed of the network 118, the process 200 occurs in less than one second.

The process 200 begins by proceeding from step 201 to step 202, in which a request by the publisher site 116 for an advertisement to display when the publisher site 116 is displayed on the client 102 is transmitted by the client 102 to the exchange server 150. The exchange server 150 in step 203 receives the request, and in step 204 the exchange server 204 sends a right-to-bid request to each of a plurality of advertisement servers 130. In step 205, each advertisement server 130 receives the right-to-bid request from the exchange server 150, and in step 206 each advertisement server 130 generates a response to the right-to-bid request based on a respective set of advertisement server rules 134. The response is sent by each advertisement server 130 to the exchange server 150 in step 207, and the exchange server 150 receives the responses in step 208. In step 208, the exchange server selects a winning response, from the plurality of received responses of step 208, based on the exchange rules 158 stored in the memory 152 of the exchange server 150. In step 210, the information for the advertisement associated with the winning response is provided by the exchange server 150 to the client 102, which the client 102 receives in step 211, and the client 102 displays the advertisement associated with the winning response in step 212. The process 200 ends in step 213.

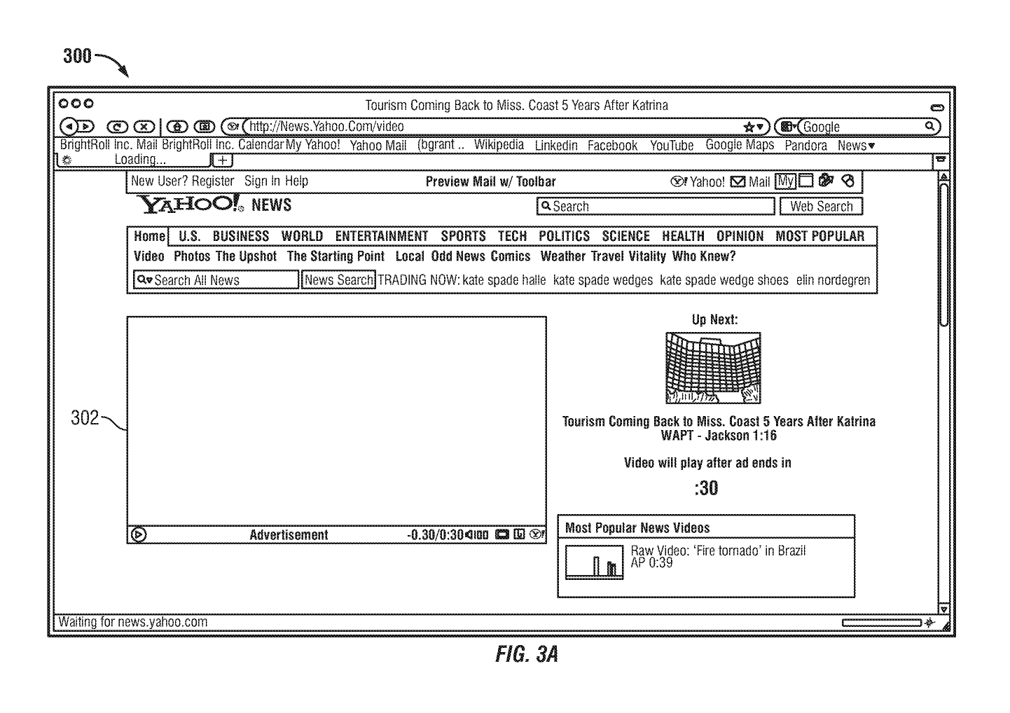

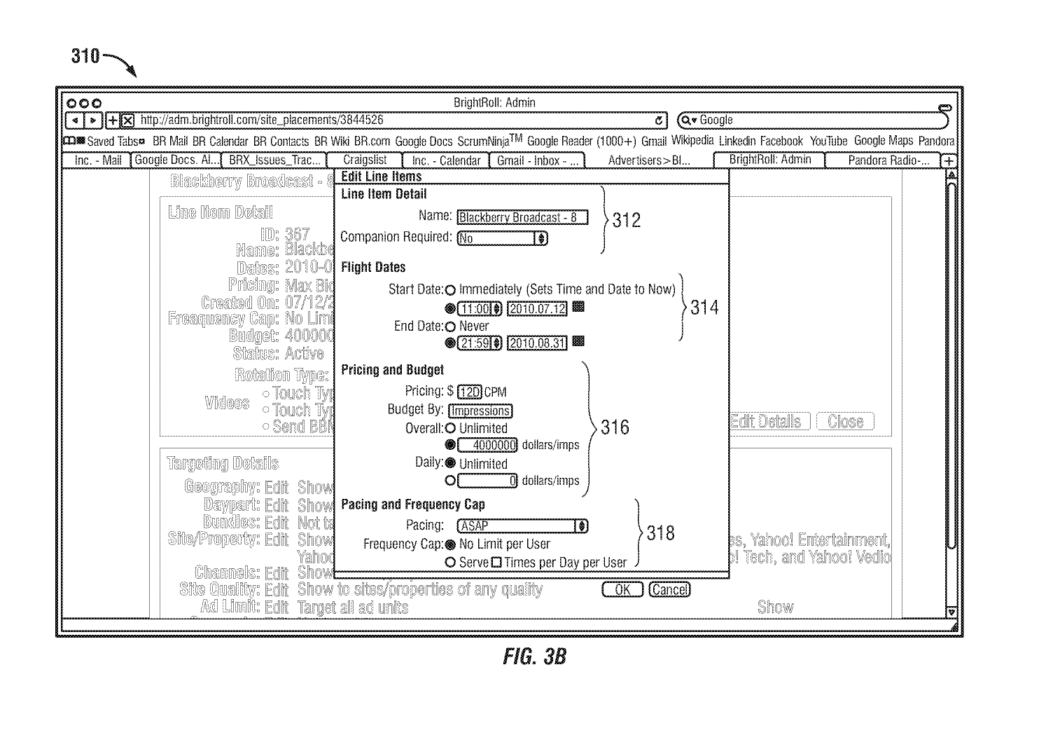

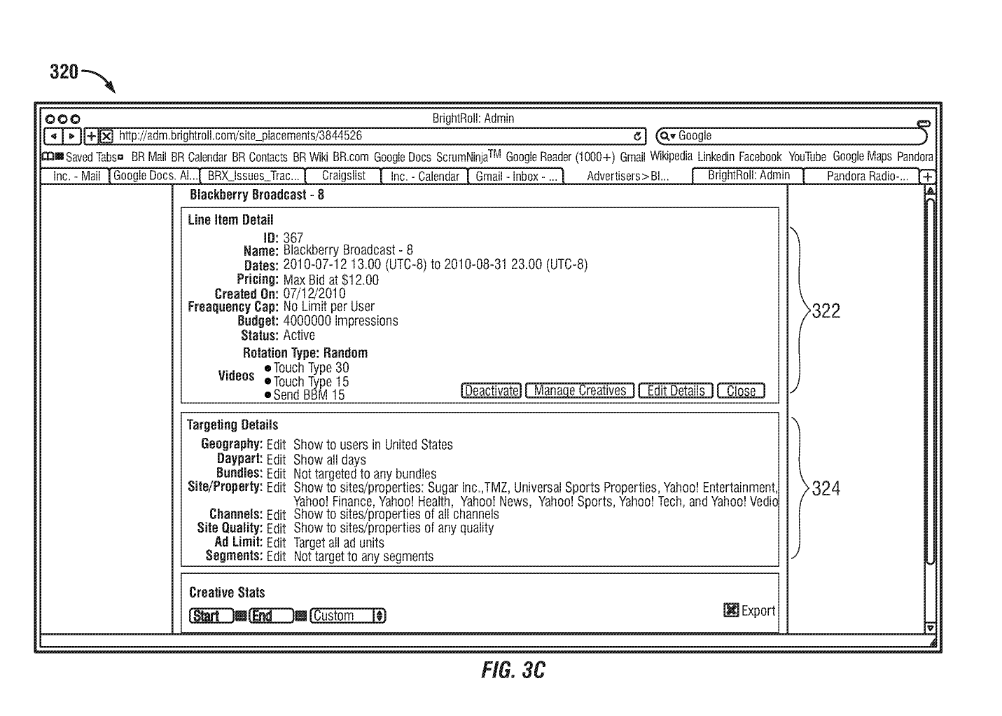

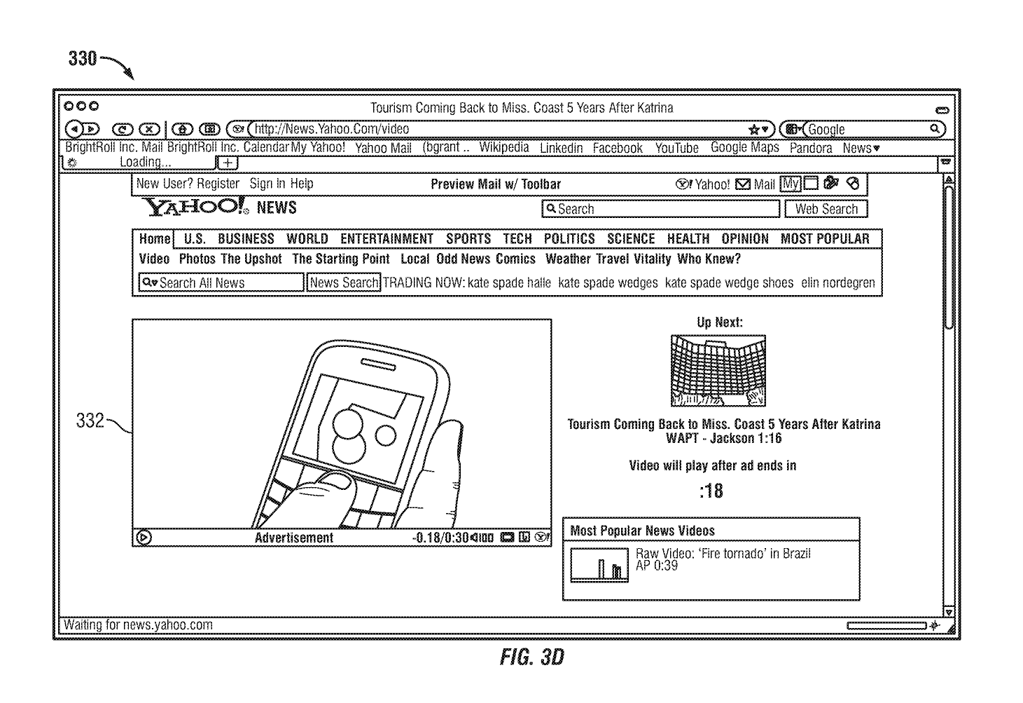

Having set forth in FIG. 2 an exemplary process 200 for procuring placement of an advertisement over a network 118 using the exchange server 150 of FIG. 1A, an example will now be described using the exemplary process 200 of FIG. 2, a news publisher site, and an advertisement for a product, a mobile device, such as a cellular telephone, although the advertisement could be for any other product or service. The process 200 begins by proceeding from step 201 to step 202, in which a request by a news publisher web site (e.g., publisher site 116) for a video advertisement to display on the client 102 is transmitted by the client 102 to the exchange server 150. FIG. 3A is an exemplary screenshot 300 that illustrates the news publisher web site using a web browser. The news publisher web site includes a pre-defined space 302 to display the video advertisement. The exchange server 150 in step 203 receives the request from the client 102, and in step 204 the exchange server 204 sends a right-to-bid request to each of a plurality of advertisement servers 130. In step 205, each advertisement server 130 receives the right-to-bid request from the exchange server 150, and in step 206 each advertisement server 130 generates a response to the right-to-bid request based on a respective set of advertisement server rules 134.

FIG. 3B is an exemplary screenshot 310 that illustrates an entry, from the set of advertisement server rules 134, of line item details for the cellular telephone advertisement. As discussed above, the entry, as part of the set of advertisement server rules 134, can either be stored in the memory of the advertisement server 132 or the memory 152 of the exchange server. The entry for the cellular telephone advertisement includes line item detail information 312, flight details 314 (e.g., the duration of time for which an advertisement campaign is live), pricing and budget information 316, and pacing and frequency cap information 318. Providing advertisers with the ability to enter details for the placement of their advertisements advantageously allows the advertiser to target potential customers based on the features discussed above (e.g., geo-targeting, by category, etc.). By allowing advertisers to set pricing and budget information 316, the exchange server 150 facilitates efficient pricing of advertisement inventory (e.g. a price conducive to both advertisers and publishers).

The response to the right-to-bid request from the exchange server 150 is sent by each advertisement server 130 back to the exchange server 150 in step 207, and the exchange server 150 receives the responses in step 208. FIG. 3C is an exemplary screenshot 320 that illustrates information regarding the entry of FIG. 3B after it has been processed by the exchange server 150. The processed entry for the cellular telephone advertisement includes the information 322 from the line item entry of FIG. 3B, as well as targeting detail information provided by the exchange server 150. In step 208, the exchange server 150 selects a winning response, from the plurality of received responses of step 208, based on the exchange rules 158 (e.g., including all processed entries) stored in the memory 152 of the exchange server 150. In step 210, the information for the advertisement associated with the winning response is provided by the exchange server 150 to the client 102, which the client 102 receives in step 211, and the client 102 displays the advertisement associated with the winning response in step 212. FIG. 3D is an exemplary screenshot 330 that illustrates the advertisement 332 for the cellular phone associated with the entries of FIGS. 3B and 3C being displayed on the news publisher web site using the web browser. The process 200 ends in step 213.

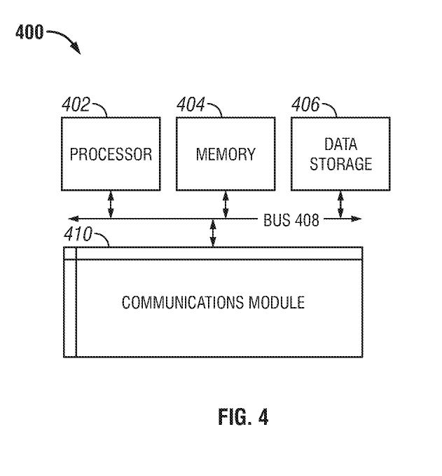

FIG. 4 is a block diagram illustrating an example of a computer system with which the exchange server 150 of FIG. 1A can be implemented. In certain embodiments, the computer system 400 may be implemented using software, hardware, or a combination of both, either in a dedicated server, or integrated into another entity, or distributed across multiple entities.

Computer system 400 (e.g., exchange server 150) includes a bus 408 or other communication mechanism for communicating information, and a processor 402 (e.g., processor 154) coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. Computer system 400 also includes a memory 404 (e.g., memory 152), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The instructions may be implemented according to any method well known to those of skill in the art, including, but not limited to, computer languages such as data-oriented languages (e.g., SQL, dBase), system languages (e.g., C, Objective-C, C++, Assembly), architectural languages (e.g., Java), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402. Computer system 400 further includes a data storage device 406 such as a magnetic disk or optical disk, coupled to bus 408 for storing information and instructions. Computer system 400 may be coupled via communications module 460 (e.g., communications module 156) to various devices (not illustrated). The communications module 410 can be any input/output module. In certain embodiments not illustrated, the communications module 410 is configured to connect to a plurality of devices, such as an input device and/or a display device (e.g., display device 114).

According to one aspect of the present disclosure, the exchange server 150 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative embodiments, hard-wired circuitry may be used in place of or in combination with software instructions to implement various embodiments of the present disclosure. Thus, embodiments of the present disclosure are not limited to any specific combination of hardware circuitry and software.

The term “machine-readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read.

The disclosed systems and methods provide a networked advertisement exchange that processes, in near real-time and based on respective sets of rules, a request for video advertisements from a publisher site being displayed on a client, responses from a plurality of advertisement servers seeking to serve an advertisement for a bid price in response to the request, and providing the winning advertisement to the client so that it is displayed on the client.

While certain aspects and embodiments of the invention have been described, these have been presented by way of example only, and are not intended to limit the scope of the invention. Indeed, the novel methods and systems described herein may be embodied in a variety of other forms without departing from the spirit thereof. The accompanying claims and their equivalents are intended to cover such forms or modifications as would fall within the scope and spirit of the invention.

What is claimed is:

1. A networked advertisement exchange system comprising:
a memory comprising a set of exchange rules;
a processor configured to:
receive, from a client, an advertisement request;
send, to each of a plurality of advertisement servers, a right-to-bid request;
receive, from each of the plurality of advertisement servers, a response to the right-to-bid request, each response comprising a bid price or a pass;
select, based on the set of exchange rules, the winning response from the plurality of responses; and
provide, to the client in response to the advertisement request, information for an advertisement associated with the winning response, wherein the advertisement is a video.

2. The system of claim 1, wherein the advertisement is served before media content.

3. The system of claim 2, wherein the media content comprises video, audio, a game, an advertisement, an image, or a web page.

4. The system of claim 1, wherein the advertisement request comprises at least one of an IP address, advertisement format information, pricing information, site information for the site that will display the advertisement, historical information, or client information.

5. The system of claim 1, wherein the right-to-bid request comprises at least one of an IP address, advertisement information, pricing information, site information, inventory information, a time, or client information.

6. The system of claim 1, wherein the response is based on a set of rules associated with the respective advertisement server.

7. The system of claim 1, wherein the response further comprises information on a bid advertisement, or a tracking module.

8. The system of claim 1, wherein the set of exchange rules comprise rules associated with a web-site on which to display the advertisement, pricing information, or advertisement format information.

9. A method for procuring placement of an advertisement over a network comprising:
receiving, from a client, an advertisement request;
sending a right-to-bid request to each of a plurality of advertisement servers;
receiving, from each of the plurality of advertisement servers, a response to the right-to-bid request, each response comprising a bid price or a pass;
selecting, based on a set of exchange rules, the winning response from the plurality of responses; and
providing, to the client in response to the advertisement request, information for an advertisement associated with the winning response,
wherein the advertisement is a video.

10. The method of claim 9, wherein the advertisement is served before media content.

11. The method of claim 10, wherein the media content comprises video, audio, a game, an advertisement, an image, or a web page.

12. The method of claim 9, wherein the advertisement request comprises at least one of an IP address, advertisement format information, pricing information, site information for the site that will display the advertisement, historical information, or client information.

13. The method of claim 9, wherein the right-to-bid request comprises at least one of an IP address, advertisement information, pricing information, site information, inventory information, a time, or client information.

14. The method of claim 9, wherein the response is based on a set of rules associated with the respective advertisement server.

15. The method of claim 9, wherein the response further comprises information on a bid advertisement, or a tracking module.

16. The method of claim 9, wherein the set of exchange rules comprise rules associated with a web-site on which to display the advertisement, pricing information, or advertisement format information.

17. A machine-readable medium comprising machine-readable instructions for causing a processor to execute a method for procuring placement of an advertisement over a network comprising:
receiving, from a client, an advertisement request;
sending a right-to-bid request to each of a plurality of advertisement servers;
receiving, from each of the plurality of advertisement servers, a response to the right-to-bid request, each response comprising a bid price or a pass;
selecting, based on a set of exchange rules, the winning response from the plurality of responses; and
providing, to the client in response to the advertisement request, information for an advertisement associated with the winning response,
wherein the advertisement is a video.

18. The machine-readable medium of claim 17, wherein the advertisement request comprises at least one of an IP address, advertisement format information, pricing information, site information for the site that will display the advertisement, historical information, or client information.

19. The machine-readable medium of claim 17, wherein the right-to-bid request comprises at least one of an IP address, advertisement information, pricing information, site information, inventory information, a time, or client information.

20. The machine-readable medium of claim 17, wherein the response is based on a set of rules associated with the respective advertisement server.
